(19) United States
(12) Patent Application Publication
(10) Pub. No.: US 2009/0084177 A1
(43) Pub. Date: Apr. 2, 2009

(54) THERMAL FLOW MEASUREMENT SYSTEM AND METHOD

(76) Inventors: Xiaolei S. Ao, Lexington, MA (US); Edward Randall Furlong, Beverly, MA (US); Oleg Khrakovsky, Lynn, MA (US)

Correspondence Address: General Electric Company;GE Global Patent Operation, PO Box 861, 2 Corporate Drive, Suite 648, Shelton, CT, 06484, US

(21) Appl. No.: 11/862,777

(22) Filed: Sep. 27, 2007

(51) Int. Cl. G01F 1/688

(52) U.S. Cl. 73/170.12; 702/45

(57) ABSTRACT

A thermal flow measurement system includes at least first and second sensors for detecting heat loss due to fluid flowing in a conduit. The first and second sensors are spaced a predetermined distance apart. An electronics subsystem is responsive to the at least first and second sensors and configured to receive input signals from the first and second sensors including direct current and alternating current components, and to output alternating current signals for determination of flow velocity of the fluid.

### FIELD OF THE INVENTION

The embodiments of the subject invention relate to a system and method for fluid flow measurement, and in one example, thermal flow rate measurement.

### BACKGROUND OF THE INVENTION

Accurate measurement of fluid flowing through a conduit is important for many industries. The semi-conductor, water and processing industries, aviation, as well as oil and gas industries, often depend upon accurate flow rate measurements. In these and other industries or systems such as sampling systems, fluid flow rate is typically low. This can increase the difficulty of obtaining accurate measurements.

Low cost and compact form are desired for flow measurement devices, but conventional devices often fail to provide these features.

Some conventional systems for determining various properties of fluid flowing in a conduit utilize temperature sensors. One such system utilizes a single temperature sensor. See e.g. U.S. Pat. No. 6,639,506. Another system utilizes two temperatures sensors, with a heater placed therebetween. See e.g. U.S. Pat. No. 4,373,386. In one example configuration, temperature measurements are taken at various flow rates to create a calibration curve of flow versus temperature. For a given measured temperature, flow rate can be extrapolated.

Such systems use actual temperature readings and/or the heat loss of probes due to flow, or temperature measurements per se, to determine flow properties, and are typically calibrated at standard ambient conditions. As field conditions change, however, the precision of such systems suffers. Additionally, such systems use DC signals exclusively, which often leads to drift over time, caused by e.g. contamination of the thermistor or other probe used to measure temperature, thus decreasing system accuracy. Also, such systems determine average, not instantaneous, temperature measurements.

Other known systems are either not compact enough for certain applications, or are less than satisfactory to all customers due to their purported unreliability.

The use of traditional ultrasound or Coriolis techniques provide improvement for larger conduits, but at increased cost, and at sizes which often prove to be too bulky for a number of applications.

As a consequence of these shortcomings, such systems may be too large, too unreliable, and/or require frequent calibration.

### SUMMARY OF THE INVENTION

Embodiments of this invention provide a more cost-effective, more compact, and more accurate system and method for more determining flow rate of a fluid. In the various embodiments of this invention, the flow measurement system and method includes at least two sensors for detecting temperature fluctuation of a fluid flowing in a conduit. Utilizing signals from the sensors, parameters such as flow rate or velocity may be determined independently of actual temperature measurements, accuracy and reliability are improved, and frequent calibration is unnecessary.

The subject invention, however, in other embodiments, need not achieve all these objectives and the claims hereof should not be limited to structures or methods capable of achieving these objectives.

The subject invention features a thermal flow measurement system including at least first and second sensors for detecting heat loss due to fluid flowing in a conduit. The first and second sensors are spaced a predetermined distance apart. An electronics subsystem is responsive to the at least first and second sensors and configured to receive input signals from the first and second sensors including direct current and alternating current components, and output alternating current signals for determination of flow velocity of the fluid. In one embodiment the electronics subsystem is further configured to output digitized alternating current signals, and the electronics subsystem may include at least one analog-to-digital converter for digitizing the alternating current signals. In one variation, at least one digitized signal is a digitized alternating current component of the input signal from the first sensor and at least one digitized alternating current component of the input signal from the second sensor.

The system typically further includes a processing subsystem which is responsive to the electronics subsystem and configured to analyze the alternating current signals. In one example, the processing subsystem is configured to detect time delay between the alternating current signals, and may be additionally configured to detect the time delay between the alternating current signals by cross correlation. The processing subsystem is typically configured to calculate the flow velocity of the fluid in the conduit utilizing information included in the alternating current signals and the distance between the first and second sensors. In one embodiment, the processing subsystem is configured to calculate the flow velocity of the fluid in the conduit utilizing information included in digitized alternating current signals and the distance between the first and second sensors.

The sensors may be thermistors, and in one variation the sensors are included in a microelectromechanical device. The distance between the first and second sensors may be approximately two millimeters, up to approximately one-quarter the inner diameter of the conduit, and all distances therebetween. At least one of the first and second sensors may be on the exterior of the conduit, or at least a portion of one of the first and second sensors may be in the fluid flow.

The subject invention also features a thermal flow measurement system including at least first and second sensors for detecting temperature of a fluid flowing in a conduit, the first and second sensors spaced a predetermined distance apart. An electronics subsystem is responsive to the at least first and second sensors and configured to receive input signals from the first and second sensors including direct current and alternating current components, and output digitized alternating current signals for determination of flow velocity of the fluid.

The subject invention further features a thermal flow measurement method including detecting heat loss in at least two sensors at spaced apart locations due to fluid flowing in a conduit, receiving signals indicative of the heat loss including direct current and alternating current components, separating the direct current components from the alternating current components of the signals, and outputting alternating current signals from determining flow velocity of the fluid in the conduit. In one embodiment the method further includes digitizing the alternating current components. In one aspect the method includes determining the flow velocity of the fluid in the conduit, in one example by detecting time delay between the alternating current signals. Detecting the time delay between the alternating current signals may include cross-correlating the alternating current signals. In one embodiment, determining the flow velocity of the fluid in the conduit includes calculating the flow velocity utilizing the spaced apart distance between the two spaced apart locations and information included in the alternating current signals. The at least two spaced apart locations may be on the exterior of the conduit, or the at least two spaced apart locations may be in the fluid flow.

The subject invention also features a flow measurement method including detecting temperature of a fluid flowing in a conduit at least two spaced apart locations, receiving signals indicative of the detected temperatures including direct current and alternating current components, separating the direct current components from the alternating current components of the signals, and outputting digitized alternating current signals for determining flow velocity of the fluid in the conduit.

### BRIEF DESCRIPTION OF THE SEVERAL VIEWS OF THE DRAWINGS

Other objects, features and advantages will occur to those skilled in the art from the following description of the embodiments and the accompanying drawings, in which:

FIG. 1 is schematic perspective view of one embodiment of a thermal flow measurement in accordance with the subject invention;

FIG. 2 is a schematic partial cross-sectional view of temperature sensors inserted into fluid flowing in a conduit in accordance with one aspect of the subject invention;

FIG. 3 is a schematic partial cross-sectional view of temperature sensors on the exterior of a conduit in accordance with one aspect of the subject invention;

FIG. 4 is a schematic block diagram showing the primary components of one embodiment of an electronics subsystem in accordance with one aspect of the subject invention;

FIG. 5 is one example of a plot of amplitude and time showing AC signal waveforms in accordance with one aspect of the subject invention;

FIG. 6 is a plot showing test results for a thermal flow measurement system in accordance with the subject invention under simulated flow conditions;

FIG. 7 is a plot showing repeatability test results for a thermal flow measurement system in accordance with the subject invention under simulated flow conditions;

FIG. 8 is a schematic block diagram showing the primary method steps of one embodiment of a flow measurement method in accordance with the subject invention; and

FIG. 9 is a schematic block diagram showing the primary method steps of another embodiment of a flow measurement method in accordance with the subject invention.

### DETAILED DESCRIPTION OF THE INVENTION

Aside from the embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

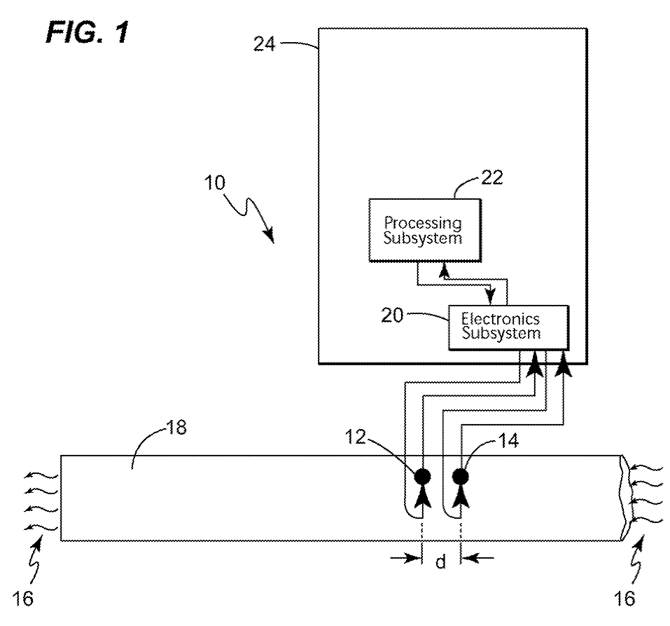

In one embodiment of the subject invention, thermal flow measurement system 10, shown schematically in FIG. 1, includes at least sensor or probe 12 and sensor or probe 14, spaced a distance d apart, each for detecting heat loss due to fluid 16 flowing in conduit or pipe 18 and/or the temperature of fluid 16. In the case of detection of heat loss, the heat loss is the heat loss in each of the sensors due to the fluid flow. Since point temperature or heat loss measurements are taken by sensors 12 and 14, the distance d between the sensors can be small. In one non-limiting embodiment, the distance d is in the range from two millimeters to one quarter of the internal diameter of the pipe or conduit, including all subranges therebetween. Thus, sensors 12 and 14 may be included in a microelectromechanical (MEMS) device for example, if desired for a particular application. Accordingly, thermal flow measurement system 10, FIG. 1 is suitable for use with small pipes or conduits, although it is not so limited. Due to the distance between the sensors which can be very small, it is advantageous for sensors 12 and 14 to have a fast response, such as five (5) Hz or greater in one example. Therefore, in one variation sensors 12 and 14 are thermistors, and in another variation a wheatstone bridge may be included in electronics subsystem 20 for sensing heat loss due to flow by maintaining constant thermistor currents or constant thermistor temperature. Other types of temperature sensors such as hot wires may also be utilized.

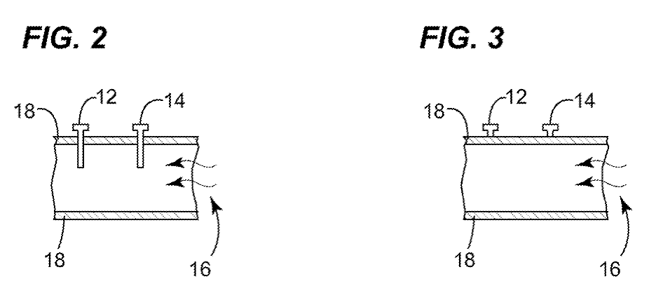

In one configuration, at least a portion of sensor 12 and/or sensor 14, FIG. 2 is in the fluid flow 16, for example by insertion into pre-existing holes or nozzles in conduit 18, or by hot tapping into or drilling conduit 18. In the latter example, sensor 12 and/or 14 may be part of an assembly which is inserted into the conduit. In another configuration, at least one of sensors 12 and 14, FIG. 3 is on the exterior of conduit or pipe 18 and not in fluid flow 16. Such clamp-on sensors, or sensors held in place on the conduit by clamping means for example, are suited to pipes made of material having good thermal conductivity.

Typically, sensors or probes 12 and 14 are located in the axial direction from one another as shown in FIG. 1, but this is not a necessary limitation. The sensors may be located laterally from one another, or at various angles or at various orientations, to determine different fluid flow rates or velocity components of fluid flow 16. Also, the subject invention is not limited to two sensors or probes, and for example an array of probes may be utilized to create a fluid flow velocity profile. The determination of fluid flow rate or velocity is discussed further below.

Thermal flow measurement system 10 further includes electronics subsystem 20 and processing subsystem 22, which are typically configured as part of a single device 24, although this is not a necessary limitation of the invention. Electronics subsystem 20 is responsive to first and second sensors 12 and 14.

In conventional systems, typically an average temperature and average fluid flow velocity of the fluid flowing in the conduit is determined using the DC component of the sensor signals. In such systems, drift occurs which is associated with the DC component of the signals.

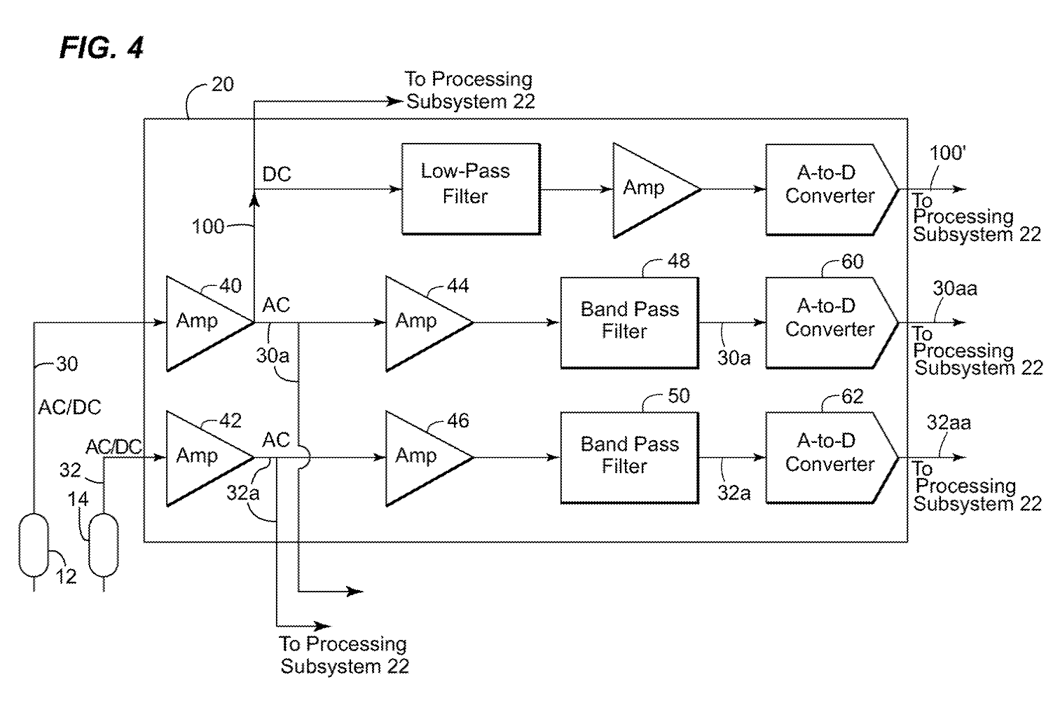

In accordance with one embodiment of the subject invention, electronic subsystem 20, FIG. 4 is configured to receive input signals 30 and 32, respectively, from sensors 12 and 14, which typically include direct current (DC) and alternating current (AC) components, and to output AC signals 30a, 32a for determination of flow velocity or flow rate in fluid 16 flowing in conduit 18. AC signal 30a is the alternating current component of input signal 30 from sensor 12, and AC signal 32a is the alternating current component of input signal 32 from sensor 14.

In accordance with one aspect of the subject invention, electronics subsystem 20 subtracts or separates out the DC component of input signals 30 and 32, in one example utilizing amplifiers 40 and 42, respectively, although other ways to separate the AC and DC signal components may be used. Electronics subsystem 20 then outputs AC signals 30a, 32a for determination of fluid flow rate. By subtracting or separating out the DC component and utilizing the AC component of the input signals from the sensors, drift in the temperature sensors, e.g. sensors 12 and 14, can be greatly reduced or eliminated. Also in contrast to conventional systems, instantaneous temperature based on fluid turbulence can be determined utilizing the AC component of the input signals from the temperature sensors.

In one variation, the AC signals may be further processed by amplifiers 44 and 46 and/or band pass filters 48 and 50, and/or may undergo further processing in order to provide signals at frequencies as desired for analysis by processing subsystem 22, although these are not necessary limitations of the subject invention.

If the signal-to-noise ratio of signals 30 and 32 is sufficiently high, AC signals 30a and 32a may be utilized in order to determine fluid flow velocity and/or other parameters.

In one embodiment, electronics subsystem 20 further includes analog-to-digital converter 60 for digitizing AC signal 30a and analog-to-digital converter 62 for digitizing AC signal 32a. In this embodiment output signals 30aa and 32aa from electronic subsystem 20 are digitized AC signals provided to processing subsystem 22 for analysis, and these digitized AC signals are particularly suitable when the input signals from the sensors have a low signal-to-noise ratio. Although two analog-to-digital converters are shown in FIG. 4, this is not a necessary limitation, and the number of analog-to-digital converters may vary depending on, for example, the number of sensors.

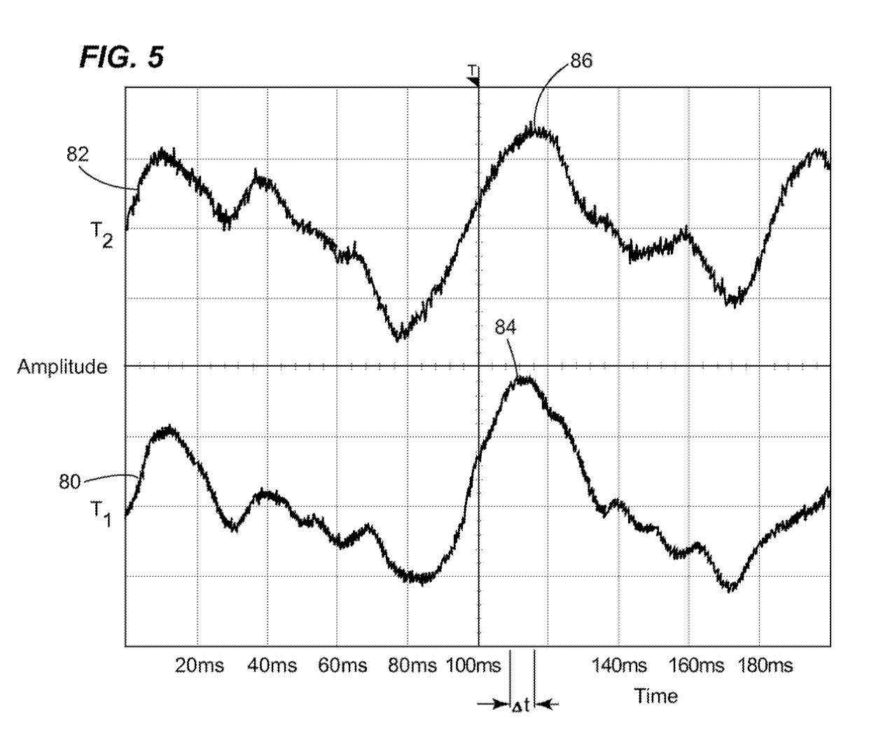

FIG. 5 shows examples of AC signals from two temperature sensors, such as sensors 12 and 14, FIG. 1, after passing through electronics subsystem 20. The AC signals may represent heat loss in the sensors due to fluid flow, or temperature readings from the sensors. Signals (AC waveforms) 80 (at time t₁) and 82 (at later time t₂) are similar, in this example corresponding to heat loss of the two sensors caused by the fluid flow. It can be seen, however, that the maximum 84 of signal 80, e.g. originating from upstream temperature sensor 14, does not occur at the same time as the maximum 86 of signal 82 originating from downstream temperature sensor 12. Instead, there is a time delay Δt between the maximums 84 and 86 of each of AC signals 80 and 82. The time difference Δt is the time delay or phase shift from which processing subsystem 22, together with the known distance between temperature sensors, e.g. distance d, can determine fluid flow velocity, where Δt is the time period during which a given portion of the flowing fluid passes from one sensor to another sensor, for example from an upstream sensor to a downstream sensor.

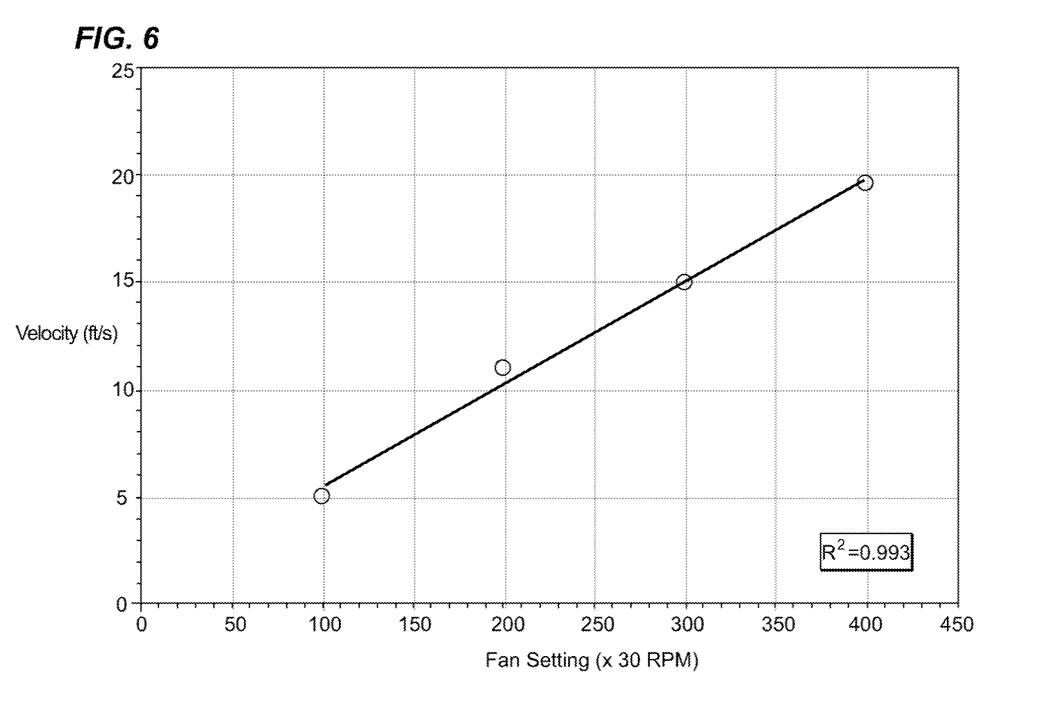

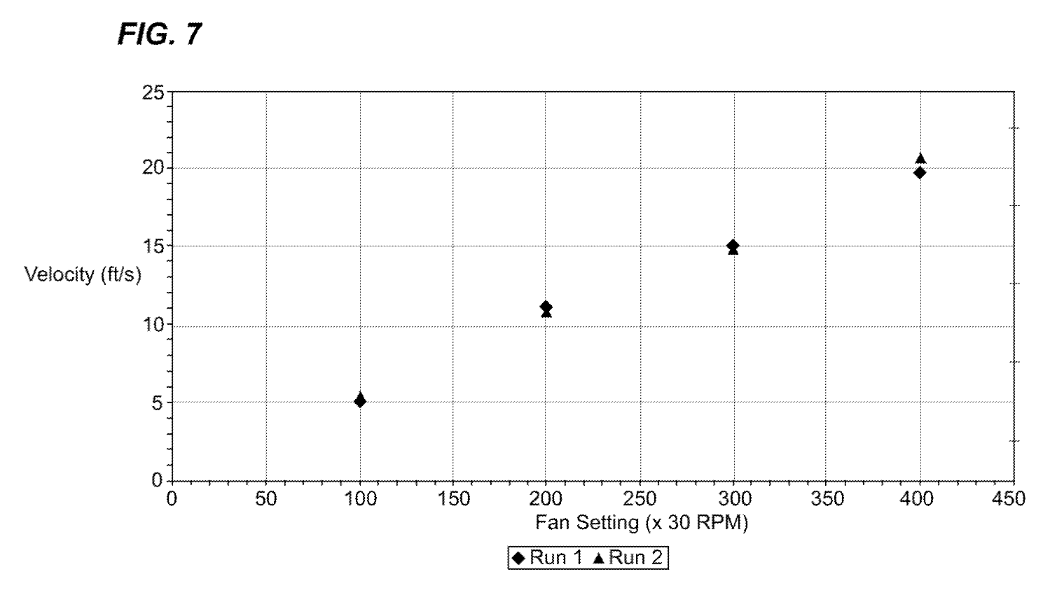

FIG. 6 shows test results when a fan was used to simulate fluid flow. The fan setting is on the y-axis, and as shown, where fan setting was tripled, for example from 3000 to 9000 RPM, the calculated flow velocity of the fluid in the conduit was also tripled, from 5 ft/s to 15 ft/s. Repeatability of these results under the same simulated flow conditions is shown in FIG. 7, where two test runs were conducted.

Processing subsystem 22, FIG. 1 is configured to be responsive to electronics subsystem 20 and to analyze the AC signals, whether or not digitized, and in one variation is configured to detect the time delay Δt between AC signals 80 and 82, FIG. 4, in one example by utilizing cross-correlation techniques very similar to cross-correlation techniques as are known in the art of ultrasound flow meters. Non-limiting examples of cross-correlation techniques suitable for use with the embodiments of the subject invention are set forth in U.S. Pat. No. 4,787,252 and U.S. Pat. No. 6,293,156, each of which is incorporated herein by reference. Cross-correlation is a high resolution timing technique to resolve the time difference between two signals (such as two AC signals), or data arrays, which in the example of two sensors may be resolved by the maximum value of the cross-correlation coefficient given by

$${R}_{80.82} ( τ ) = {\int }_{- ∞}^{∞} f ( t ) f ( t + τ ) d t \qquad ( 1 )$$

where R_{80,82}(τ) is the cross-correlation coefficient, f(t) represents the signal 80 from one sensor (e.g. sensor 14) and f(t+τ) represents the signal 82 from another sensor (e.g. sensor 12) at a later time. The time delay Δt may then be determined when the cross-correlation coefficient has its maximum value as given by

R_{80,82}(Δt)=max(R_{80,82}(τ)) (2)

Thus cross-correlation is particularly suited to very small time delays Δt or phase shifts between two signals, such as signals from the first and second temperature sensors 12 and 14. Utilizing information included in the AC signals received from electronic subsystem 20, such as the time delay Δt between maximums 84 and 86, FIG. 4 and the known distance d between sensors such as first and second temperature sensors 12 and 14, FIG. 1, processing subsystem 22 is configured to calculate the velocity or flow rate of fluid 16 in conduit 18, which may be determined from Δt and distance d in ways known to those skilled in the art. In one example, fluid flow rate or velocity is determined by

$$v = \frac{d}{Δ t} \qquad ( 3 )$$

where v is the fluid flow rate or velocity, d is the distance between the sensors, and Δt is the time delay between signals from the sensors.

It will be recognized by those skilled in the art that the subject invention is not necessarily limited to determining fluid flow velocity and that other characteristics of fluid flow may be determined which are based on temperature and/or fluid flow velocity, such as mass flow rate.

Additionally, processing subsystem 22 may be configured to utilize the DC component of the input signals from the temperature sensors which has been separated out by electronics subsystem 20, for example DC component 100, FIG. 4 of input signal 30 (and/or digitized DC signal 100′). DC signal(s) 100 (and/or 100′) may be utilized in the conventional manner, e.g. to determine average mass flow rate or other desired parameters by measuring the temperature difference between sensors. Such parameters may be compared, and/or utilized to as a check or for redundancy.

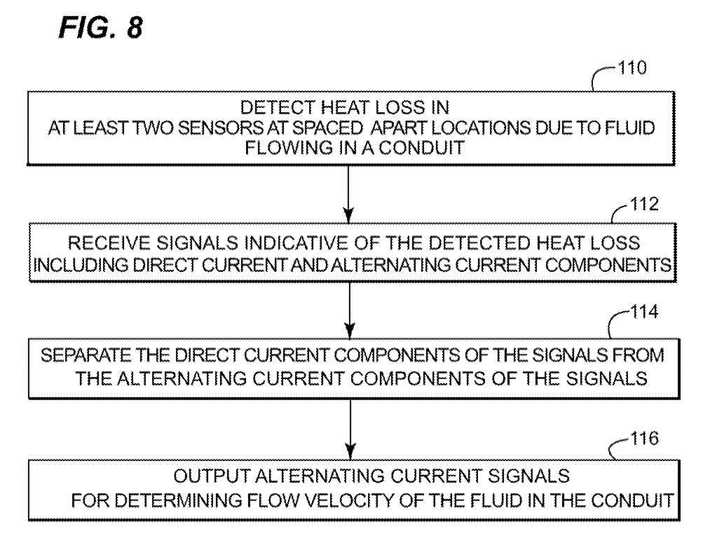

A summary of one embodiment of a method in accordance with the subject invention is shown in flowchart form in FIG. 8, including: detecting heat loss in at least two spaced apart sensors due to fluid flow, step 110, such as by temperature sensors 12 and 14, FIG. 1; receiving signals including direct current and alternating current components indicative of the detected temperatures, step 112, FIG. 8, for example by electronics subsystem 20, FIG. 1; separating the direct current components of the signals from the alternating current components of the signals, step 114, for example with electronics subsystem 20; and outputting alternating current signals for determining the flow velocity of the fluid flowing in the conduit, step 116. In one variation, the method includes digitizing the alternating current component. In one aspect, the method includes determining the flow velocity of the fluid in the conduit, and in one variation determining flow velocity includes detecting the time delay between the alternating current signals, in one example by cross-correlating the alternating current signals. In another embodiment, determining flow velocity of the fluid in the conduit includes calculating the flow velocity utilizing the spaced apart distance between the two locations or sensors and information included in the alternating current signals. In one configuration, the spaced apart locations are on the exterior of the conduit, and in another configuration, one of the at least two spaced apart locations is in the fluid flow.

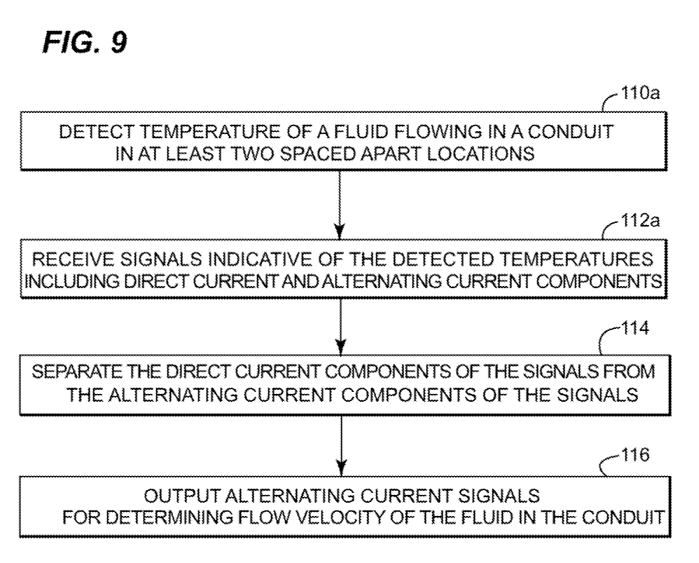

In another embodiment, rather than or in addition to detecting heat loss due to flow in at least two spaced apart sensors, the method includes step 110a, FIG. 9 including detecting the temperature of a fluid flowing in a conduit at least two spaced apart locations in the fluid, and step 112a, receiving signals indicative of the detected temperatures which include direct current and alternating current components.

Although the steps set forth herein are set forth in a particular sequence, it will be understood that this sequence is not limiting, and that steps may be undertaken simultaneously or out of order. Additionally, one or more of the method steps may be combined, and are not necessarily mutually exclusive.

Accordingly, it is clear that embodiments of the system and method of the subject invention provide cost-effective thermal flow measurement with improved reliability and accuracy.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A thermal flow measurement system comprising:
at least first and second sensors for detecting heat loss due to fluid flowing in a conduit, said first and second sensors spaced a predetermined distance apart;
an electronics subsystem responsive to the at least first and second sensors and configured to:
receive input signals from the first and second sensors including direct current and alternating current components; and
output alternating current signals for determination of flow velocity of the fluid.

2. The system of claim 1 in which the electronics subsystem is further configured to output digitized alternating current signals.

3. The system of claim 2 in which the electronics subsystem includes at least one analog-to-digital converter for digitizing the alternating current signals.

4. The system of claim 3 in which at least one digitized signal is a digitized alternating current component of the input signal from the first sensor and at least one digitized signal is a digitized alternating current component of the input signal from the second sensor.

5. The system of claim 1 further including a processing subsystem responsive to the electronics subsystem and configured to analyze the alternating current signals.

6. The system of claim 5 in which the processing subsystem is configured to detect a time delay between the alternating current signals.

7. The system of claim 6 in which the processing subsystem is configured to detect the time delay between the alternating current signals by cross-correlation.

8. The system of claim 1 in which the processing subsystem is configured to calculate the flow velocity of the fluid in the conduit utilizing information included in the alternating current signals and the distance between the first and second sensors.

9. The system of claim 1 in which the sensors are thermistors.

10. The system of claim 1 in which the sensors are included in a micro-electromechanical device.

11. The system of claim 1 in which the distance between the first and second sensors is two millimeters.

12. The system of claim 1 in which the distance between the first and second sensors is one-quarter the inner diameter of the conduit.

13. The system of claim 1 in which at least one of the first and second sensors is on the exterior of the conduit.

14. The system of claim 1 in which at least a portion of one of the first and second sensors is in the fluid flow.

15. The system of claim 2 in which the processing subsystem is configured to calculate the flow velocity of the fluid in the conduit utilizing information included in digitized alternating current signals and the distance between the first and second sensors.

16. A thermal flow measurement system comprising:
at least first and second sensors for detecting temperature of a fluid flowing in a conduit, said first and second sensors spaced a predetermined distance apart;
an electronics subsystem responsive to the at least first and second sensors and configured to:
receive input signals from the first and second sensors including direct current and alternating current components; and
output digitized alternating current signals for determination of flow velocity of the fluid.

17. A thermal flow measurement method comprising:
detecting heat loss in at least two sensors at spaced apart locations due to fluid flowing in a conduit;
receiving signals indicative of the heat loss including direct current and alternating current components;
separating the direct current components from the alternating current components of the signals; and
outputting alternating current signals for determining flow velocity of the fluid in the conduit.

18. The method of claim 17 further including digitizing the alternating current components.

19. The method of claim 17 further including determining the flow velocity of the fluid in the conduit.

20. The method of claim 19 including detecting a time delay between the alternating current signals.

21. The method of claim 20 in which detecting the time delay between the alternating current signals includes cross-correlating the alternating current signals.

22. The method of claim 19 in which determining the flow velocity of the fluid in the conduit includes calculating the flow velocity utilizing the spaced apart distance between the two spaced apart locations and information included in the alternating current signals.

23. The method of claim 17 in which the at least two spaced apart locations are on the exterior of the conduit.

24. The method of claim 17 in which one of the at least two spaced apart locations is in the fluid flow.

25. A thermal flow measurement method comprising:
detecting temperature of a fluid flowing in a conduit at least two spaced apart locations;
receiving signals indicative of the detected temperatures including direct current and alternating current components;
separating the direct current components from the alternating current components of the signals; and
outputting digitized alternating current signals for determining flow velocity of the fluid in the conduit.
